(19) United States
(12) Patent Application Publication
(10) Pub. No.: US 2020/0016793 A1
(43) Pub. Date: Jan. 16, 2020

(54) WETTING NOZZLE HAVING WETTING POCKETS FOR PRODUCING A FIBROUS TAPE WETTED WITH A POLYMER, METHOD FOR PRODUCING THIS FIBROUS TAPE, AND A WETTED FIBROUS TAPE

(71) Applicant: Covestro Deutschland AG, Leverkusen (DE)

(72) Inventors: Christian Wilms, Neuss (DE); Herbert Börger, Markt Bibart (DE); Henning Börger, Nürnberg (DE)

(21) Appl. No.: 16/495,658

(22) PCT Filed: Mar. 28, 2018
(86) PCT No.: PCT/EP2018/057911

§ 371 Date: Sep. 19, 2019

(30) Foreign Application Priority Data
Mar. 28, 2017 (EP) 17163238.3

(51) Int. Cl. B29B 15/12

(52) U.S. Cl. CPC B29B 15/122; B29K 2101/12

(57) ABSTRACT

The present disclosure relates to a wetting die having a wetting slot for producing a fiber band wetted with thermoplastic. The wetting die comprises two wetting pockets, wherein the wetting die has a respective wetting pocket at each of two horizontally lateral ends of an opening of the wetting slot. The present disclosure also relates to a process for producing a fiber band wetted with thermoplastic and to a process for producing a fiber band impregnated with thermoplastic. The present disclosure further relates to a fiber band impregnated with thermoplastic, a multilayer composite, exterior and interior trim of automobiles, and housing material.

The present invention provides a wetting die with wetting pockets for producing a fiber band wetted with polymer. The wetting die is in the form of a vertically oriented slot die having a wetting slot whose opening is aligned horizontally and runs perpendicular to the advancement direction of the fiber band. The wetting die has a respective wetting pocket adjacent to but separate from each of the two horizontally lateral ends of the opening of the wetting slot, wherein the wetting pockets extend in the advancement direction of the wetted fiber band.

The present invention also provides a process for continuous production of a fiber band wetted with polymer comprising continuous fibers oriented unidirectionally in the running direction of the wetted fiber band using the wetting die according to the invention.

The present invention further provides an impregnated fiber band producible with the apparatus according to the invention or the process according to the invention. This impregnated fiber band is produced from the wetted fiber band through at least one further process step, namely one or more impregnation steps.

The longest axis of a fiber band is also referred to as the running direction. “Continuous fiber” is to be understood as meaning that the length of the reinforcing fiber corresponds essentially to the dimension of the fiber band to be wetted in the orientation of the fiber. “Unidirectionally” in association with “fiber” is to be understood as meaning that the fibers in the fiber band are oriented in just one direction. The advancement direction is the direction in which the fiber band is moved forward during production of the wetted fiber band. The advancement direction and the running direction are parallel to one another but the advancement direction also has a sense of direction as a result of the forward motion of the fiber band during production of the wetted fiber band.

The use of fiber-reinforced materials has increased steadily in recent decades on account of their outstanding specific properties. Fiber-reinforced materials are used especially in structures subject to acceleration, in order to allow a reduction in weight and hence minimize energy consumption without losses in strength or stiffness of the material.

A fiber-reinforced material, also called fiber composite or composite for short, is an at least biphasic material consisting of a matrix material in which fibers are essentially fully embedded and encapsulated. The matrix has a shape-conferring function, is intended to protect the fibers from outside influences and is necessary to transmit forces between the fibers and introduce external loads. The fibers make a crucial contribution to the mechanical performance of the material, with glass, carbon, polymer, basalt or natural fibers often being employed in industry. Depending on the intended use, matrix materials employed are generally thermosetting or thermoplastic polymers, occasionally even elastomers.

Thermosetting polymers are already long established in a great many industries. However, a decisive disadvantage is the lengthy curing time which leads to correspondingly lengthy cycle times during processing to afford components. This makes thermoset-based composites unattractive especially for high-volume industry applications. By contrast, thermoplastic-based composites, provided they are in the form of fully-consolidated semifinished products, e.g. as continuous fiber-reinforced sheets or profiles, are often merely heated, formed and cooled when subjected to further processing, which may nowadays be achieved in cycle times of well under one minute. The processing may also be combined with further process steps, for example insert-molding with thermoplastics, which makes it possible to achieve a very high degree of automation and integration of functions.

Reinforcing materials used are essentially semifinished textile products such as wovens, multi-ply non-crimp fabrics or nonwovens (also known as batts or random-laid fiber mats). It is a characteristic of these forms of fiber reinforcement that the orientation of the fiber—and thus the force paths in the subsequent component—is already determined in the semifinished textile product. While this does allow direct production of a multidirectionally reinforced composite it has disadvantages in terms of flexibility of ply construction, mechanical properties and economy. In thermoplastic-based systems these semifinished textile products are typically impregnated with polymer under the action of pressure and temperature and then cut to size and subjected to further processing as a cured sheet.

In addition to these already established systems based on semifinished textile products, thermoplastic-based tapes, i.e. fiber bands impregnated with a thermoplastic polymer, are increasing in importance. These offer economic advantages since the process step of semifinished textile product production can be dispensed with. These thermoplastic-based tapes are suitable for producing multi-ply constructions, particularly also for producing multidirectional constructions. When reference is made here to “fiber bands” this is to be understood as meaning not only fiber bands wetted with thermoplastic, “wetted fiber bands” for short, but also fiber bands impregnated with thermoplastic, “impregnated fiber bands” for short, and unwetted and unimpregnated fiber bands. In the context of the present invention “wetted fiber band” is to be understood as meaning a fiber band in which in a length section under consideration the entire fiber band is at least externally surrounded by thermoplastic. It is not necessary for each individual fiber to be directly surrounded by thermoplastic; it is sufficient when the surfaces of the fibers disposed at the surface of the fiber band are surrounded with thermoplastic. In the context of the present invention “impregnated fiber band” is to be understood as meaning a fiber band in which in a length section under consideration at least 80% of the surface area of all fibers is directly surrounded with the respectively employed thermoplastic; it is not necessary for the surface area of each fiber to be directly surrounded with thermoplastic to an extent of at least 80% but rather it is sufficient when the sum of the surface areas of all fibers is directly surrounded with thermoplastic to an extent of at least 80%. Such a longitudinal section preferably has a length of at least 10 mm, more preferably at least 100 mm, particularly preferably at least 500 mm, especially preferably at least 1000 mm.

A process and an apparatus for producing a unidirectionally continuous fiber-reinforced impregnated fiber band are described for example in WO 2012 123 302 A1, the disclosure of which is hereby fully incorporated into the description of the present invention by reference.

In the apparatus disclosed in WO 2012 123 302 A1, in particular in FIGS. 1 and 3 and the accompanying parts of the description, reference numeral 12 also shows a wetting die, referred to therein as an application means. This wetting die has a slot die (reference numeral 14 in WO 2012 123 302 A1) in which a die channel (reference numeral 15 in WO 2012 123 302 A1) is connected to a melt volume (reference numeral 13 in WO 2012 123 302 A1).

The first disadvantage of the apparatus disclosed in WO 2012 123 302 A1 is that too much of the thermoplastic polymer is applied at the outer edges of the fiber band. The reason for this is that the width of the wetting slot must be greater than the width of the fiber band to ensure sufficient wetting of the long edges, i.e. of the outer edges in the running direction, of the fiber band. However, reducing the width of the wetting slot results in incomplete wetting of the wetted fiber band along its long edges. Both an excess and a deficiency of wetting along the long edges of the wetted fiber band result in the course of further processing in an impregnated fiber band that is unsuitable for further use, for example for the production of constructions composed of a plurality of face-to-face joined impregnated fiber bands. Such incorrectly wetted fiber bands result in impregnated fiber bands in which the fiber volume content in the region of the long edges of the impregnated fiber bands is too high (deficient wetting and consequent deficient impregnation) or too low (excessive wetting and consequent excessive impregnation). This in turn results in undesired deviations in both thermal and mechanical properties in the region of the long edges of the impregnated fiber band compared to the regions of the impregnated fiber bands outside the long edges of the impregnated fiber bands. Thus, deficient wetting can cause the impregnated fiber bands to have insufficient mechanical stability at the edges and undergo fraying. In addition, both deficient and excessive wetting results in failure to maintain the desired dimensions of the fiber band.

Since in the production of multi-ply, multidirectional constructions the long edges of the impregnated fiber bands are located not only at the edges of the constructions but also inside the constructions, undesired defects in the structure of such multi-ply constructions, resulting even in unusability, will occur. As a result, the impregnated fiber bands produced according to the prior art must be trimmed along the long edges. Only this makes it possible to provide an impregnated fiber band suitable for further use. This constitutes a further processing step which entails apparatus complexity, makes the process more prone to errors and takes additional working time.

In the context of the present invention “fiber volume content” is to be understood as meaning the quotient of the volume of the fibers in a certain region of the fiber band and the sum of the volume of the thermoplastic and the volume of the fibers, in each case neglecting the volumes of any air inclusions.

Good wetting is thus harder to achieve the higher the intended fiber volume content of the impregnated fiber band. Typical fiber volume contents are in the range from 30% to 70%, preferably in the range from 35% to 60%, particularly preferably in the range from 40% to 50%.

To achieve impregnations of 90%, i.e. for at least 90% of the surface area of all fibers to be directly surrounded with the respectively employed thermoplastic in a length section under consideration, the deviation from the desired fiber volume content per width section must be not more than 5%, preferably not more than 2%. This requires very uniform wetting of the fiber band with the thermoplastic.

A width section of the fiber band in the running direction is 1%, preferably 0.5%, particularly preferably 0.2%, very particularly preferably 0.1%, of the total width of the fiber band, but at least 0.5 mm and not more than 5 mm.

However, another disadvantage of trimming the impregnated fiber band is the loss of material which is especially significant when costly starting materials, for example a polycarbonate as the thermoplastic matrix and carbon fibers as the fiber material, are employed.

The apparatus disclosed in WO 2012 123 302 A1 has the second disadvantage that the wetting of the fiber band can be adjusted only with difficulty. Reasons for this include the relatively high viscosities of the employed thermoplastics at the temperatures prevailing during the impregnation and the fiber bands that are intrinsically inhomogeneous due to agglomeration of the fibers. The viscosities of the employed thermoplastics are between 10 and 300 Pa*s. However, the temperatures during wetting cannot be increased as desired since this resulted not only in elevated energy consumption but also in decomposition of the thermoplastics. The lack of adjustability of the wetting of the fiber band has the result that the fiber band is often insufficiently wetted, i.e. in a length section under consideration the entire fiber band is not at least outwardly surrounded by thermoplastic and the deviation from the desired fiber volume content per width section is more than 2%, even more than 5%, often more than 10%. Such a defectively wetted fiber band does not allow production of an impregnated fiber band in which at least 90% of the surface area of all fibers of an impregnated fiber band is impregnated with the respectively employed thermoplastic.

An impregnated fiber band which does not have at least 90% of the surface area of all fibers of an impregnated fiber band impregnated with the respectively employed thermoplastic is not suitable for further processing and must therefore be disposed of as scrap. This entails costs not only due to material loss but also for disposal of the unusable material.

However it is also not possible to arbitrarily increase the pressure of a thermoplastic on the fiber band to accomplish a wetting of the fiber band with the thermoplastic. An excessive pressure has the result that excess thermoplastic issues from the sides of the fiber band which in turn results in elevated costs through material losses and reduced dimensional accuracy of both the wetted fiber band and the impregnated fiber band.

As previously explained the costs of material losses are significant in particular when using costly starting materials such as for example a polycarbonate as the thermoplastic matrix and carbon fibers as the fiber material.

As well as their high cost, polycarbonates have the further disadvantage compared to typically used thermoplastics of having little tendency to creep and hence having a propensity to crack under constant stress. This is highly problematic particularly for use in composites comprising continuous fibers because composites comprising continuous fibers in their plastic matrix are under constant stress due to the continuous fibers. Until now, polycarbonates have therefore in practice played only a subordinate role as a plastic matrix for such composites comprising endless fibers.

It is, however, desirable in principle to widen the field of application of polycarbonates to also include impregnated fiber bands because compared to the other customary thermoplastics, such as polyamide or polypropylene, polycarbonates exhibit reduced volume shrinkage during solidification. Polycarbonates further exhibit a higher glass transition temperature Tg, a greater heat resistance and a lower water absorption compared to other thermoplastics.

Impregnated fiber bands comprising polycarbonate as the matrix material moreover make it possible to provide a multilayer composite having an aesthetically pleasing, low-corrugation surface coupled with good mechanical properties. Such a multilayer composite constructed from impregnated fiber bands comprising polycarbonate as the matrix material exhibits metal-like haptics, optics and acoustics.

These properties also make such a multilayer composite suitable as a housing material for housings for electronic devices, in particular portable electronic devices such as laptops or smartphones, and for exterior and interior trim of automobiles, since such a multilayer composite can bear mechanical load as well as offering an exceptional outer appearance.

In order to make polycarbonate amenable to the production of impregnated fiber bands it is thus also necessary to take particular care during wetting of the fiber band, which is not assured in the prior art.

It is an object of the present invention to overcome the disadvantages of the prior art.

It is a particular object of the present invention to provide an apparatus suitable for wetting an unwetted fiber band such that in a length section under consideration the entire fiber band is at least outwardly surrounded by thermoplastic and that the deviation from the desired fiber volume content per width section is not more than 5%, preferably not more than 2%.

In addition the amount of the excess of thermoplastic necessary to bring about such a wetting shall be by preference not more than 5%, preferably not more than 3%, particularly preferably not more than 1%, of the amount of thermoplastic altogether used for the wetting of an unwetted fiber band, i.e. the amount adhering in the impregnated fiber band plus the amount of the excess. This impregnated fiber band produced from the wetted fiber band shall not require trimming to achieve the desired degree of impregnation.

It is further preferred when at least 90%, particularly preferably at least 95%, of the surface area of all fibers of an impregnated fiber band produced from the fiber band wetted according to the invention is impregnated with the respectively employed thermoplastic. It is further preferred when the degree of impregnation in each width section of the impregnated fiber band deviates from the average degree of impregnation of the impregnated fiber band by not more than 10%, preferably by not more than 5%, particularly preferably by not more than 2%.

Provided the fiber band is not to be trimmed along its long edges after impregnation, such a degree of impregnation is achievable only through good wetting of the fiber band with the employed thermoplastic.

It is a further object of the present invention to provide an apparatus with which wetted fiber bands may be produced with polycarbonate as the matrix material. Impregnated fiber bands may then be produced from these wetted fiber bands through at least one further process step, in particular one or more impregnation steps.

These impregnated fiber bands produced from the wetted fiber bands having polycarbonate as the matrix material shall be suitable for allowing manufacture therefrom of multilayer composites having metal-like haptics, optics and acoustics and an excellent outward appearance as well as the ability to bear mechanical load. Such multilayer composites are then suitable as housing material for housings of electronic devices, especially portable electronic devices such as laptops or smartphones, and for exterior and interior trim of automobiles.

The object is achieved by the apparatus according to the present main claim. The apparatus according to the invention is characterized in that it comprises a wetting die with wetting pockets for producing a fiber band wetted with thermoplastic.

The wetting die has a respective wetting pocket at each of the two horizontally lateral ends of the opening of the wetting slot.

In this case the wetting die has a respective wetting pocket adjoining but separate from each of the two horizontally lateral ends of the opening of the wetting slot.

Such a wetting pocket directly adjoins the opening of the wetting slot laterally in the horizontal direction and continues in the advancement direction of the wetted fiber band, wherein the wetting pocket has a shallower depth than the wetting slot and is connected to the feed of thermoplastic only via the wetting slot. In plan view, i.e. looking vertically onto the opening of the die slot, the wetting pocket may be semi-circular, semi-oval, in the shape of a circle fraction having an angle A of 120° to 135° with an adjacent triangle tapering to a point in the advancement direction or may have any other useful shape. It is preferable when in plan view the wetting pocket is semicircular or in the form of a circle fraction having an angle A of 120° to 135° with an adjacent triangle tapering to a point in the advancement direction, in particular in the shape of a circle fraction having an angle A of 120° to 135° with an adjacent triangle tapering to a point in the advancement direction. The leg of the triangle which adjoins the contour of the circle fraction in the advancement direction proceeds tangentially from the circle fraction. A thus-formed wetting pocket makes it possible not only to reserve sufficient matrix material for wetting in particular where the matrix material comes into contact with the hitherto unwetted or only slightly wetted fiber band, but also to provide an ever decreasing amount of matrix material as the degree of wetting increases, in order to avoid excess wetting. The end of the triangle tapering to a point moreover achieves a sharp separation between the now wetted fiber band and the matrix material of the wetting pocket.

The two wetting pockets at the two lateral ends of the opening of the wetting slot are preferably arranged and configured mirror-symmetrically to one another in the advancement direction, though it is also possible to provide wetting pockets not arranged mirror-symmetrically to one another at the two lateral ends of the opening of the wetting slot. The radius R of a wetting pocket is adapted to the viscosity of the employed thermoplastic. The radius is preferably from 0.5 mm to 2 mm, in particular about 1 mm.

It is preferable according to the invention when the wetting die is constructed from two or more parts movable with respect to one another. In this way the width of the slot and thus also the width of the opening of the slot can be adapted to the type and composition of the matrix material and the conditions for producing the impregnated fiber band. The opening of the slot generally has a width of 0.1 to 1 mm.

In the context of the present invention an impregnated fiber band has a matrix consisting to an extent of at least 50 wt %, preferably at least 70 wt %, particularly preferably at least 90 wt %, of one or more thermoplastics. The thermoplastic is preferably selected from one or more of the series comprising polycarbonate, polyamide, polyethylene, polypropylene, polyphenylene sulfone, polyetherimide, a polyether ketone such as polyetheretherketone, polyetherketoneketone, polyetheretheretherketone, polyetheretherketoneketone, poly(etherketone-etherketoneketone) and thermoplastic polyurethane. Thermoplastic polycarbonate is particularly preferred.

In addition, the matrix material may contain up to 50.0 wt %, preferably up to 30 wt %, particularly preferably up to 10 wt %, of customary additives.

This group comprises flame retardants, anti-drip agents, thermal stabilizers, demolding agents, antioxidants, UV absorbers, IR absorbers, antistats, optical brighteners, light-scattering agents, colorants such as pigments, including inorganic pigments, carbon black and/or dyes, and inorganic fillers in amounts customary for polycarbonate. These additives can be added singly or else in admixture.

Such additives as are typically added in the case of polycarbonates are described, for example, in EP-A 0 839 623, WO-A 96/15102, EP-A 0 500 496 or “Plastics Additives Handbook”, Hans Zweifel, 5th Edition 2000, Hanser Verlag, Munich.

When reference is made here to polycarbonate this also comprehends mixtures of different polycarbonates. Polycarbonate is furthermore used here as an umbrella term and thus comprises both homopolycarbonates and copolycarbonates. The polycarbonates may further be linear or branched in known fashion.

It is preferable when the polycarbonate consists to an extent of 70 wt %, preferably 80 wt %, particularly preferably 90 wt %, or essentially, in particular to an extent of 100 wt %, of a linear polycarbonate.

The polycarbonates may be produced in known fashion from diphenols, carbonic acid derivatives and optionally chain terminators and branching agents. Particulars pertaining to the production of polycarbonates have been well known to a person skilled in the art for at least about 40 years. Reference may be made here for example to Schnell, Chemistry and Physics of Polycarbonates, Polymer Reviews, Volume 9, Interscience Publishers, New York, London, Sydney 1964, to D. Freitag, U. Grigo, P. R. Müller, H. Nouvertné, BAYER AG, Polycarbonates in Encyclopedia of Polymer Science and Engineering, Volume 11, Second Edition, 1988, pages 648-718, and finally to U. Grigo, K. Kirchner and P. R. Müdler Polycarbonate in BeckerBraun, Kunststoff-Handbuch, Volume 31, Polycarbonate, Polyacetale, Polyester, Celluloseester, Carl Hanser Verlag Munich, Vienna 1992, pages 117-299.

Aromatic polycarbonates are produced for example by reaction of diphenols with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Production via a melt polymerization process by reaction of diphenols with for example diphenyl carbonate is likewise possible. Diphenols suitable for producing polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from isatin derivatives or from phenolphthalein derivatives and also their ring-alkylated, ring-arylated and ring-halogenated compounds.

In the case of the diphenols based on phthalimides preference is given to using for example 2-aralkyl-3,3′-bis(4-hydroxyphenyl)phthalimides or 2-aryl-3,3′-bis(4-hydroxyphenyl)phthalimides such as 2-phenyl-3,3′-bis(4-hydroxyphenyl)phthalimide, 2-alkyl-3,3′-bis(4-hydroxyphenyl)phthalimides, such as 2-butyl-3,3′-bis(4-hydroxyphenyl)phthalimides, 2-propyl-3,3′-bis(4-hydroxyphenyl)phthalimides, 2-ethyl-3,3′-bis(4-hydroxyphenyl)phthalimides or 2-methyl-3,3′-bis(4-hydroxyphenyl)phthalimides and also diphenols based on isatins substituted at the nitrogen such as 3,3-bis(4-hydroxyphenyl)-1-phenyl-1H-indol-2-one or 2,2-bis(4-hydroxyphenyl)-1-phenyl-1H-indol-3-one.

Preferred diphenols are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane.

Particularly preferred diphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A.

These and other suitable diphenols are described for example in U.S. Pat. Nos. 3,028,635, 2,999,825, 3,148,172, 2,991,273, 3,271,367, 4,982,014 and 2,999,846, in DE-A 1 570 703, DE-A 2063 050, DE-A 2 036 052, DE-A 2 211 956 and DE-A 3 832 396, in FR-A 1 561 518, in the monograph H. Schnell, Chemistry and Physics of Polycarbonates, Interscience Publishers, New York 1964 and also in JP-A 620391986, JP-A 620401986 and JP-A 1055501986.

In the case of homopolycarbonates only one diphenol is employed and in the case of copolycarbonates two or more diphenols are employed.

Suitable carbonic acid derivatives are for example phosgene and diphenyl carbonate. Suitable chain terminators that may be employed in the production of polycarbonates are monophenols. Suitable monophenols are for example phenol itself, alkylphenols such as cresols, p-tert-butylphenol, cumylphenol and mixtures thereof.

Preferred chain terminators are phenols which are mono or polysubstituted with linear or branched, preferably unsubstituted, C1- to C30-alkyl radicals or with tert-butyl. Particularly preferred chain terminators are phenol, cumylphenol and/or p-tert-butylphenol. The amount of chain terminator to be employed is preferably 0.1 to 5 mol % based on moles of diphenols employed in each case. The addition of the chain terminators may be carried out before, during or after the reaction with a carboxylic acid derivative.

Suitable branching agents are the trifunctional or more than trifunctional compounds known in polycarbonate chemistry, in particular those having three or more than three phenolic OH groups.

Suitable branching agents are for example 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4-dihydroxytriphenyl)methyl)benzene and 3,3-bis(3-methyl-4-hydroxyphenyl)-2-oxo-2,3-dihydroindole.

The amount of the branching agents for optional use is preferably from 0.05 mol % to 3.00 mol % based on moles of diphenols used in each case. The branching agents can either be initially charged with the diphenols and the chain terminators in the aqueous alkaline phase or added dissolved in an organic solvent before the phosgenation. In the case of the transesterification process the branching agents are employed together with the diphenols.

Particularly preferred polycarbonates are the homopolycarbonate based on bisphenol A, the homopolycarbonate based on 1,3-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane.

Copolycarbonates too may also be used. To produce these copolycarbonates 1 wt % to 25 wt %, preferably 2.5 wt % to 25 wt %, particularly preferably 2.5 wt % to 10 wt %, based on the total amount of diphenols to be employed, of polydiorganosiloxanes having hydroxyaryloxy end groups may be employed. These are known (U.S. Pat. Nos. 3,419,634, 3,189,662, EP 0 122 535, U.S. Pat. No. 5,227,449) and producible by literature processes. Likewise suitable are polydiorganosiloxane-containing copolycarbonates; the production of polydiorganosiloxane-containing copolycarbonates is described in DE-A 3 334 782 for example.

The polycarbonates may be present alone or as a mixture of polycarbonates. It is also possible to employ the polycarbonate or the mixture of polycarbonates together with one or more plastics distinct from polycarbonate as blend partners.

Employable blend partners include polyamides, polyesters, in particular polybutylene terephthalate and polyethylene terephthalate, polylactide, polyether, thermoplastic polyurethane, polyacetal, fluoropolymer, in particular polyvinylidene fluoride, polyether sulfones, polyolefin, in particular polyethylene and polypropylene, polyimide, polyacrylate, in particular poly(methyl)methacrylate, polyphenylene oxide, polyphenylene sulfide, polyetherketone, polyaryletherketone, styrene polymers, in particular polystyrene, styrene copolymers, in particular styrene-acrylonitrile copolymer, acrylonitrile-butadiene-styrene block copolymers and polyvinyl chloride.

Polyamides suitable in accordance with the invention are likewise known or producible by literature processes.

Polyamides suitable in accordance with the invention are known homopolyamides, copolyamides and mixtures of these polyamides. These may be semicrystalline and/or amorphous polyamides. Suitable semicrystalline polyamides include polyamide-6, polyamide-6,6 and mixtures and corresponding copolymers of these components. Also contemplated are semicrystalline polyamides whose acid component consists entirely or partly of terephthalic acid and/or isophthalic acid and/or suberic acid and/or sebacic acid and/or azelaic acid and/or adipic acid and/or cyclohexane dicarboxylic acid, whose diamine component consists entirely or partly of m- and/or p-xylylenediamine and/or hexamethylenediamine and/or 2,2,4-trimethylhexamethylenediamine and/or 2,4,4-trimethylhexamethylenediamine and/or isophoronediamine and whose composition is known in principle.

Mention may also be made of polyamides produced entirely or partly from lactams having 7 to 1 carbon atoms in the ring, optionally with co-use of one or more of the abovementioned starting components.

Particularly preferred semicrystalline polyamides are polyamide-6 and polyamide-6,6 and mixtures thereof. Amorphous polyamides that may be used include known products. These are obtained by polycondensation of diamines such as ethylenediamine, hexamethylenediamine, decamethylenediamine, 2,2,4- and/or 2,4,4-trimethylhexamethylenediamine, m- and/or p-xylylenediamine, bis(4-aminocyclohexyl)methane, bis(4-aminocyclohexyl)propane, 3,3′-dimethyl-4,4′-diaminodicyclohexylmethane, 3-aminomethyl-3,5,5-trimethylcyclohexylamine, 2,5- and/or 2,6-bis(aminomethyl)norbornane and/or 1,4-diaminomethylcyclohexane with dicarboxylic acids such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Also suitable are copolymers obtained by polycondensation of two or more monomers, as are copolymers produced by addition of aminocarboxylic acids such as e-aminocaproic acid, w-aminoundecanoic acid or w-aminolauric acid or lactams thereof.

Particularly suitable amorphous polyamides are polyamides produced from isophthalic acid, hexamethylenediamine and further diamines such as 4,4-diaminodicyclohexylmethane, isophoronediamine, 2,2,4- and/or 2,4,4-trimethylhexamethylenediamine, 2,5- and/or 2,6-bis(aminomethyl)norbornene; or from isophthalic acid, 4,4′-diaminodicyclohexylmethane and ε-caprolactam; or from isophthalic acid, 3,3′-dimethyl-4,4′-diaminodicyclohexylmethane and laurolactam; or from terephthalic acid and the isomer mixture composed of 2,24- and/or 2,4,4-trimethylhexamethylenediamine.

Instead of pure 4,4′-diaminodicyclohexylmethane it is also possible to use mixtures of the geometrically isomeric diaminedicyclohexylmethanes composed of
70 to 99 mol % of the 4,4′-diamino isomer,
1 to 30 mol % of the 2,4′-diamino isomer and
0 to 2 mol % of the 2,2′-diamino isomer,
optionally correspondingly more-highly condensed diamines obtained by hydrogenation of technical-grade diaminodiphenylmethane. Up to 30% of the isophthalic acid may be replaced by terephthalic acid.

The polyamides preferably have a relative viscosity (measured using a 1 wt % solution in m-cresol at 25° C.) of 2.0 to 5.0, particularly preferably of 2.5 to 4.0.

Thermoplastic polyurethanes suitable in accordance with the invention are likewise known or producible by literature processes.

An overview of the production, properties and applications of thermoplastic polyurethanes (TPU) may be found for example in Kunststoff Handbuch [G. Becker, D. Braun], volume 7 “Polyurethane”, Munich, Vienna, Carl Hanser Verlag, 1983.

TPUs are usually constructed from linear polyols (macrodiols), such as polyester, polyether or polycarbonate diols, organic diisocyanates and short-chain, mostly difunctional alcohols (chain extenders). Said TPUs may be produced in continuous or batchwise fashion. The best-known production processes are the belt process (GB-A 1 057 018) and the extruder process (DE-A 19 64 834).

The thermoplastic polyurethanes used are reaction products of
I) organic diisocyanates
II) polyols
III) chain extenders.

Diisocyanates (I) that may be used include aromatic, aliphatic, araliphatic, heterocyclic and cycloaliphatic diisocyanates or mixtures of these diisocyanates (cf HOUBEN-WEYL “Methoden der organischen Chemie”, Volume E20 “Makromolekulare Stoffe”, Georg Thieme Verlag, Stuttgart, New York 1987, pp. 1587-1593 or Justus Liebigs Annalen der Chemie, 562, pages 75 to 136).

Specific examples include: aliphatic diisocyanates, such as hexamethylene diisocyanate, cycloaliphatic diisocyanates, such as isophorone diisocyanate, 1,4-cyclohexane diisocyanate, 1-methyl-2,4-cyclohexane diisocyanate and 1-methyl-2,6-cyclohexane diisocyanate and also the corresponding isomer mixtures, 4,4′-dicyclohexylmethane diisocyanate, 2,4′-dicyclohexylmethane diisocyanate and 2,2′-dicyclohexylmethane diisocyanate and also the corresponding isomer mixtures, aromatic diisocyanates, such as 2,4-tolylene diisocyanate, mixtures of 2,4-tolylene diisocyanate and 2,6-tolylene diisocyanate, 4,4′-diphenylmethane diisocyanate, 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates and 2,4′-diphenylmethane diisocyanates, 4,4′-diisocyanato-1,2-diphenylethane and 1,5-naphthylene diisocyanate. Preference is given to using 1,6-hexamethylene diisocyanate, isophorone diisocyanate, dicyclohexylmethane diisocyanate, diphenylmethane diisocyanate isomer mixtures having a 4,4′-diphenylmethane diisocyanate content of >96 wt % and in particular 4,4′-diphenylmethane diisocyanate and 1,5-naphthylene diisocyanate. The recited diisocyanates may be employed singly or in the form of mixtures with one another. They may also be used together with up to 15 wt % (based on the total amount of diisocyanate) of a polyisocyanate, for example triphenylmethane 4,4′,4″-triisocyanate or polyphenylpolymethylene polyisocyanates.

Zerewitinoff-active polyols (II) are those having on average not less than 1.8 to not more than 3.0 zerewitinoff-active hydrogen atoms and a number-average molecular weight M̅ₙ of 500 to 10 000 g/mol, preferably 500 to 6000 g/mol.

This includes, in addition to compounds comprising amino groups, thiol groups or carboxyl groups, in particular compounds comprising two to three, preferably two, hydroxyl groups, specifically those having number-average molecular weights M̅ₙ of 500 to 10 000 g/mol, particularly preferably those having a number-average molecular weight M̅ₙ of 500 to 6000 g/mol, for example hydroxyl-containing polyesters, polyethers, polycarbonates and polyesteramides or mixtures thereof.

Suitable polyether diols may be produced by reacting one or more alkylene oxides having 2 to 4 carbon atoms in the alkylene radical with a starter molecule comprising two active hydrogen atoms in bonded form. Examples of alkylene oxides include: ethylene oxide, 1,2-propylene oxide, epichlorohydrin and 1,2-butylene oxide and 2,3-butylene oxide. Preference is given to using ethylene oxide, propylene oxide and mixtures of 1,2-propylene oxide and ethylene oxide. The alkylene oxides can be used singly, alternately in succession or as mixtures. Contemplated starter molecules include for example: water, amino alcohols, such as N-alkyldiethanolamines, for example N-methyldiethanolamine, and diols such as ethylene glycol, 1,3-propylene glycol, 1,4-butanediol and 1,6-hexanediol. It is optionally also possible to use mixtures of starter molecules. Suitable polyetherols further include the hydroxyl-containing polymerization products of tetrahydrofuran. Trifunctional polyethers may also be used in proportions of 0 to 30 wt % based on the bifunctional polyethers but at most in an amount that provides a product that is still thermoplastically processable. The essentially linear polyether diols preferably have number-average molecular weights M̅ₙ of 500 to 10 000 g/mol, particularly preferably 500 to 6000 g/mol. They may be used either individually or in the form of mixtures with one another.

Suitable polyester diols may be produced from, for example, dicarboxylic acids having 2 to 12 carbon atoms, preferably 4 to 6 carbon atoms, and polyhydric alcohols. Contemplated dicarboxylic acids include for example: aliphatic dicarboxylic acids such as succinic acid, glutaric acid, adipic acid, suberic acid, azelaic acid and sebacic acid, or aromatic dicarboxylic acids such as phthalic acid, isophthalic acid and terephthalic acid. The dicarboxylic acids may be used individually or as mixtures, for example in the form of a succinic, glutaric and adipic acid mixture. To produce the polyester diols, it may be advantageous to use the corresponding dicarboxylic acid derivatives such as carboxylic diesters having from 1 to 4 carbon atoms in the alcohol radical, carboxylic anhydrides or carboxylic acid chlorides instead of the dicarboxylic acids. Examples of polyhydric alcohols are glycols having 2 to 10 and preferably 2 to 6 carbon atoms, for example ethylene glycol, diethylene glycol, butane-1,4-diol, pentane-1,5-diol, hexane-1,6-diol, decane-1,10-diol, 2,2-dimethylpropane-1,3-diol, propane-1,3-diol and dipropylene glycol. Depending on the desired properties, the polyhydric alcohols may be used alone or in admixture with one another. Also suitable are esters of carbonic acid with the recited diols, in particular those having 4 to 6 carbon atoms, such as butane-1,4-diol or hexane-1,6-diol, condensation products of ω-hydroxycarboxylic acids such as ω-hydroxycaproic acid or polymerization products of lactones, for example optionally substituted ω-caprolactones. Polyester diols used are preferably ethanediol polyadipates, butane-1,4-diol polyadipates, ethanediol butane-1,4-diol polyadipates, hexane-1,6-diol neopentyl glycol polyadipates, hexane-1,6-diol butane-1,4-diol polyadipates, and polycaprolactones. The polyester diols have number-average molecular weights M̅ₙ of 500 to 10 000 g/mol, particularly preferably 600 to 6000 g/mol, and may be used individually or in the form of mixtures with one another.

Zerewitinoff-active polyols (III) are so-called chain extenders and have on average 1.8 to 3.0 zerewitinoff-active hydrogen atoms and have a number-average molecular weight M̅ₙ of 60 to 500 g/mol. This is to be understood as meaning not only compounds having amino groups, thiol groups or carboxyl groups, but also those having two to three, preferably two, hydroxyl groups.

Employed chain extenders are diols or diamines having a molecular weight of 60 to 495 g/mol, preferably aliphatic diols having 2 to 14 carbon atoms, for example ethanediol, 1,2-propanediol, 1,3-propanediol, 1,4-butanediol, 2,3-butanediol, 1,5-pentanediol, 1,6-hexanediol, diethylene glycol and dipropylene glycol. Also suitable, however, are diesters of terephthalic acid with glycols having 2 to 4 carbon atoms, for example terephthalic acid bis-ethylene glycol or terephthalic acid bis-butane-1,4-diol, hydroxyalkylene ethers of hydroquinone, for example 1,4-di(β-hydroxyethyl)hydroquinone, ethoxylated bisphenols, for example 1,4-di(β-hydroxyethyl)bisphenol A, (cyclo)aliphatic diamines, such as isophoronediamine, ethylenediamine, propylene-1,2-diamine, propylene-1,3-diamine, N-methylpropylene-1,3-diamine, N,N′-dimethylethylenediamine and aromatic diamines such as tolylene-2,4-diamine, tolylene-2,6-diamine, 3,5-diethyltolylene-2,4-diamine or 3,5-diethyltolylene-2,6-diamine or primary mono-, di-, tri- or tetraalkyl-substituted 4,4′-diaminodiphenylmethanes. Particularly preferably employed chain extenders are ethanediol, 1,4-butanediol, 1,6-hexanediol, 1,4-di(β-hydroxyethyl)hydroquinone or 1,4-di(β-hydroxyethyl)bisphenol A. Mixtures of the abovementioned chain extenders may also be employed. In addition, relatively small amounts of triols may also be added.

Compounds that are monofunctional toward isocyanates may be employed in proportions of up to 2 wt % based on thermoplastic polyurethane, as so-called chain terminators or demolding aids. Examples of suitable compounds are monoamines such as butyl- and dibutylamine, octylamine, stearylamine, N-methylstearylamine, pyrrolidine, piperidine or cyclohexylamine, monoalcohols such as butanol, 2-ethylhexanol, octanol, dodecanol, stearyl alcohol, the various amyl alcohols, cyclohexanol and ethylene glycol monomethyl ether.

The relative amounts of the compounds (II) and (III) are preferably chosen such that the ratio of the sum of the isocyanate groups in (I) to the sum of the zerewitinoff-active hydrogen atoms in (II) and (III) is 0.85:1 to 1.2:1, preferably 0.95:1 to 1.1:1.

The thermoplastic polyurethane elastomers (TPUs) employed in accordance with the invention may comprise as auxiliary and additive substances up to a maximum of 20 wt % based on the total amount of TPU of the customary auxiliary and additive substances. Typical auxiliary and additive substances are catalysts, pigments, colorants, flame retardants, stabilizers against aging and weathering effects, plasticizers, glidants and demolding agents, fungistatic and bacteriostatic substances and fillers and mixtures thereof.

Suitable catalysts are the customary tertiary amines known from the prior art, for example triethylamine, dimethylcyclohexylamine, N-methylmorpholine, N,N′-dimethylpiperazine, 2-(dimethylaminoethoxy)ethanol, diazabicyclo[2.2.2]octane and similar and also in particular organic metal compounds such as titanic esters, iron compounds or tin compounds such as tin diacetate, tin dioctoate, tin dilaurate or the dialkyltin salts of aliphatic carboxylic acids such as dibutyltin diacetate or dibutyltin dilaurate or similar. Preferred catalysts are organic metal compounds, in particular titanate esters, iron compounds and tin compounds. The total amount of catalysts in the TPUs is generally about 0 to 5 wt %, preferably 0 to 2 wt %, based on the total amount of TPU.

Examples of further added substances are glidants, such as fatty acid esters, metal soaps thereof, fatty acid amides, fatty acid ester amides and silicone compounds, antiblocking agents, inhibitors, stabilizers against hydrolysis, light, heat and discoloration, flame retardants, dyes, pigments, inorganic and/or organic fillers and reinforcers. Reinforcers are in particular fibrous reinforcing materials such as for example inorganic fibers which are produced by prior art methods and may also be sized. Further information about the recited auxiliary and additive substances may be found in the specialist literature, for example in the monograph by J. H. Saunders and K. C. Frisch “High Polymers”, Volume XVI, Polyurethane, Part 1 and 2, Interscience Publishers 1962/1964, in “Taschenbuch für Kunststoff-Additive” by R. Gächter and H. Müller (Hanser Verlag Munich 1990) or in DE-A 29 01 774.

Further additions which may be incorporated into the TPU are thermoplastics, for example polycarbonates and acrylonitrile/butadiene/styrene terpolymers, in particular ABS. Other elastomers such as rubber, ethylene/vinyl acetate copolymers, styrene/butadiene copolymers and other TPUs may also be used.

Also suitable for incorporation are commercially available plasticizers such as phosphates, phthalates, adipates, sebacates and alkylsulfonic esters.

Polyethylene suitable in accordance with the invention is likewise known or producible by literature processes. The polyethylene may be not only PE-HD (HDPE), PE-LD (LDPE), PE-LLD (LLDPE), PE-HMW but also PE-UHMW.

The polypropylene, polyphenylene sulfone, polyetherimide and polyether ketone suitable in accordance with the invention is likewise also known or producible by literature processes.

It may generally be advantageous to add thermal stabilizers and flow improvers to the thermoplastic used for the matrix.

Fibers used in accordance with the invention are in particular natural fibers or manmade fibers or a mixture of the two. The natural fibers are preferably fibrous minerals or fibers of vegetable origin and the manmade fibers are preferably inorganic synthetic fibers or organic synthetic fibers. Glass, carbon or polymer fibers are preferred according to the invention, with glass or carbon fibers being preferred in turn.

It is very particularly preferable to employ glass fibers, in particular having a modulus of elasticity of greater than 50 GPa, preferably greater than 70 GPa, or carbon fibers, in particular having a modulus of elasticity of greater than 200 GPa, preferably greater than 230 GPa. Carbon fibers having these properties are preferred in particular. Such carbon fibers are commercially available for example from Mitsubishi Rayon CO., LtD. under the trade name Pyrofil.

The fiber volume content in the wetted fiber band is 30% to 70%, preferably 35% to 60%, particularly preferably 40 to 50 vol %.

The fiber band wetted according to the invention has the features that in a length section under consideration said fiber band is at least outwardly surrounded by thermoplastic and that the deviation from the desired fiber volume content per width section is not more than 5%, preferably not more than 2%.

The amount of the excess of thermoplastic necessary to bring about such a wetting is not more than 5%, preferably not more than 3%, particularly preferably not more than 1%, of the amount of thermoplastic altogether used for the wetting of an unwetted fiber band, i.e. the amount adhering in the impregnated fiber band plus the amount of the excess. It is therefore not necessary to trim the impregnated fiber band produced from the wetted fiber band to achieve the desired degree of impregnation.

Suitable materials for the wetting die include in particular readily machinable tempered tool steels, for example the steels 1.2311 or 1.2312.

The process according to the invention corresponds to the process described in WO 2012 123 302 A1, in particular the process described at page 1 line 26 to page 2 line 22, wherein the process according to the invention employs the wetting die according to the invention.

The impregnated fiber band may be obtained from the wetted fiber band for example by application of pressure, in turn for example by deflecting the fiber band on a roll. The impregnated fiber band may preferably be obtained by application of pressure-shear vibration according to the process described in WO 2012 123 302 A1, particularly in the process described at page 11, line 23 to page 21, line 2 and the accompanying figures.

The present invention further provides an impregnated fiber band producible with the apparatus according to the invention or the process according to the invention.

A typical impregnated fiber band generally has in the running direction a length of 100 to 3000 m, a width of 60 to 2100 mm, preferably of 500 to 1000 mm, particularly preferably of 600 to 800 mm, and a thickness of 100 to 350 μm, preferably of 120 to 200 μm. However, an impregnated fiber band having different dimensions may also be processed on the apparatus according to the invention.

The impregnated fiber band according to the invention has the feature that at least 90%, particularly preferably at least 95%, of the surface area of all fibers of an impregnated fiber band is impregnated with the respectively employed thermoplastic. It is further preferred when the degree of impregnation in each width section of the impregnated fiber band deviates from the average degree of impregnation of the impregnated fiber band by not more than 10%, preferably by not more than 5%, particularly preferably by not more than 2%.

Such an impregnated fiber band according to the invention is particularly suitable for providing a multilayer composite having an aesthetically pleasing, low-corrugation surface coupled with good mechanical properties. Such a multilayer composite constructed from impregnated fiber bands comprising polycarbonate as the matrix material exhibits metal-like haptics, optics and acoustics.

These properties also make such a multilayer composite suitable as a housing material for housings for electronic devices, in particular portable electronic devices such as laptops or smartphones, and for exterior and interior trim of automobiles, since such a multilayer composite can bear mechanical load as well as offering an exceptional outer appearance.

The invention therefore also further provides a multilayer composite produced from the impregnated fiber band according to the invention.

FIG. 1 shows in simplified form a section of the impregnation die according to the invention with a semicircular wetting pocket without any intention to limit the invention to the embodiment shown.

FIG. 2 shows in simplified form a section of the impregnation die according to the invention with a wetting pocket in the form of a 120° circle fraction with an adjacent triangle tapering to a point in the advancement direction without any intention to limit the invention to the embodiment shown.

The reference numerals have the following meanings:
1 Wetting pocket
2 Opening of the wetting slot
3 Width w of the opening of the wetting slot
4 Advancement direction
5 Angle A
6 Notional line to represent one leg of a triangle tapering to a point in the advancement direction
7 Notional line to represent the base of a triangle tapering to a point in the advancement direction
8 Radius R

1. A wetting die having a wetting slot for producing a fiber band wetted with thermoplastic, wherein the wetting die comprises two wetting pockets and wherein the wetting die has a respective wetting pocket at each of two horizontally lateral ends of an opening of the wetting slot.

2. The wetting die as claimed in claim 1, wherein in plan view the wetting pockets are semi-circular, semi-oval, or in a shape of a circle fraction having an angle A of 120° to 135° with an adjacent triangle tapering to a point in an advancement direction.

3. The wetting die as claimed in claim 2, wherein a radius R of a wetting pocket is from 0.5 mm to 2 mm.

4. The wetting die as claimed in claim 1, wherein the wetting die is manufactured from a tempered tool steel.

5. The wetting die as claimed in claim 1, wherein the wetting die is constructed from two or more parts movable with respect to one another.

6. A process for producing a fiber band wetted with thermoplastic, comprising employing an apparatus as claimed in claim 1.

7. A process for producing a fiber band impregnated with thermoplastic, comprising the process of claim 6 and, in a further step, performing an impregnation by application of pressure or by application of pressure-shear vibration.

8. A fiber band impregnated with thermoplastic, wherein at least 90% of a surface area of all fibers of the fiber band impregnated with thermoplastic is impregnated with the respectively employed thermoplastic.

9. The fiber band impregnated with thermoplastic as claimed in claim 8, wherein a degree of impregnation in each width section of the impregnated fiber band deviates from an average degree of impregnation of the impregnated fiber band by not more than 10%.

10. A multilayer composite produced from an impregnated fiber band as claimed in claim 8.

11. An exterior or interior trim of an automobile or a housing material for a housing for an electronic device comprising the multilayer composite claimed in claim 10.

12. The wetting die as claimed in claim 2, wherein a radius R of a wetting pocket is about 1 mm.

13. A fiber band impregnated with thermoplastic, wherein at least 95% of a surface area of all fibers of the fiber band impregnated with thermoplastic is impregnated with the respectively employed thermoplastic.

14. The fiber band impregnated with thermoplastic as claimed in claim 8, wherein a degree of impregnation in each width section of the impregnated fiber band deviates from an average degree of impregnation of the impregnated fiber band by not more than 5%.

15. The fiber band impregnated with thermoplastic as claimed in claim 8, wherein a degree of impregnation in each width section of the impregnated fiber band deviates from an average degree of impregnation of the impregnated fiber band by not more than 2%.

16. The housing material of claim 11, wherein the housing material is for a housing for a portable electronic device.

17. The housing material of claim 11, wherein the housing material is for a housing for
a laptop or a smartphone.
